(19) United States
(12) Patent Application Publication
(10) Pub. No.: US 2009/0029008 A1
(43) Pub. Date: Jan. 29, 2009

(54) PROCESSES FOR ADHERING FOOD PARTICULATES TO DOUGH AND RELATED FOOD ITEMS

(76) Inventors: Stephen Vanos, Battle Creek, MI (US); Decai Zhang, Battle Creek, MI (US)

Correspondence Address: Dickinson Wright, PLLC;Ste. 2000, 38528 Woodward Ave., Bloomfield Hills, MI, 48304-5092, US

(21) Appl. No.: 12/178,261

(22) Filed: Jul. 23, 2008

Related U.S. Application Data
(60) Provisional application No. 60/951,244, filed on Jul. 23, 2007.

(51) Int. Cl. A23L 1/302; A21D 8/02; A23P 1/08; A21D 13/00

(52) U.S. Cl. 426/72; 426/296; 426/94

(57) ABSTRACT

The present invention provides improved methods for producing crackers with food particulates adhered to the surface, as well as the crackers produced by the methods. The processes described result in crackers which retain more topping and reduce waste. Moreover, the processes provide optional lower-fat formulations of a sweetened, hand-held food.

### CROSS REFERENCE TO RELATED APPLICATION

This application claims the benefit of application Ser. No. 60/951,244 filed on Jul. 23, 2007.

### FIELD OF THE INVENTION

The present invention provides improved processes useful for adhering food particulates to dough. The surprisingly effective inventive processes are disclosed, as are food items made by the inventive processes. The invention is therefore useful for producing products in a variety of food categories, including snack foods, R-T-E cereals, ingredient foods, and meal foods.

### BACKGROUND OF THE INVENTION

Consumers and food producers have long considered toppings on foods desirable. Products that are relatively rich, such as sweet rolls or cookies, bind toppings well, particularly if the toppings are melt-able at baking temperatures. In contrast, relatively low sugar baked products, such as crackers, are a challenge to top, particularly with toppings that are not melt-able at baking temperatures. Often, such products suffer from failure to adhere topping, or subsequent topping loss. Toppings fall off during processing, or in the packaging. The result is ingredient waste, increased cost, and consumer disapproval. Inventors have attempted to solve this problem in the past.

Prior strategies used a variety of methods to make the surface more sticky, if the toppings were not. One method is to apply moisture to the surface prior to application of the topping. Others included application of a starchy or fatty spray prior to application of the topping. In particular:

U.S. Pat. No. 7,074,446 to Heywood discloses a method to adhere particulates to a pre-baked tortilla chip via the use of a dry adhesive, such as dextrose.

U.S. Pat. No. 5,304,386 to Dugas discloses a method for making an ice cream cone with particulates embedded in the cone via a crumb mixture of fats and flour.

U.S. Pat. No. 6,537,599 to Taylor discloses a method to make cookies using rollers to drive particulates into formed high fat cookie dough.

U.S. Pat. No. 6,607,770 to Reinakien discloses a method for topping a crisp bread with sweet toppings via a thin coat of oil.

U.S. Pat. No. 4,687,673 to Harris discloses a process for making sweet bread and includes carmelization of sugar.

The present invention is distinct from those disclosed previously, with the processes especially suited for preparing low fat, sweet snack. There is a need in the food industry for improved food products and processes, particularly those with improved nutrition, as described herein. Moreover, the present processes solve a long-standing problem in commercial food making.

### SUMMARY OF THE INVENTION

The present invention provides superior processes useful to adhere melt-resistant particulates to baked cracker dough. The invention does not resort to an application of surface moisture, topical moisture in combination with starch, moisture in combination with fat, moisture in combination with starch and fat, in order to reliably adhere melt-resistant particulates. Moreover, the invention also does not rely on melt-able qualities in the topping to adhere particulates to the cracker dough. In one embodiment, the present invention provides a process for adhering particulates to dough, comprising the steps of providing a dough having a top surface and a bottom surface, introducing dry saccharide and food particulates to at lease one surface of the dough, baking the topped dough. In a more preferred embodiment, the above process includes a step of driving the particulates and saccharide into a sheeted dough prior to baking. Products made according the above processes are also included in the scope of the present invention.

The present food items are superior to those currently available to consumers in several aspects, including: the food particulates do not fall off during shipment or handling; thereby maximizing the ingredients and reducing waste; the process provides a streamlined industrial “continuous sheeting” approach to making sweet-tasting doughs in a way that was not possible with previous short-textured sweet doughs; the process increases the maximum size of particulates that can be adhered to the exterior of a crisp food item; the process allows for lower fat food items to be created; the process allows for a crisp and dry outer layer on food items; rather than an oily and granular outer layer; the processes result in food items that are less messy when eaten by hand; the present food items have superior shelf life compared to oil-based treatments that can become rancid; and the present food items do not melt at warm temperatures, as do streusels or other fat-based toppings.

Accordingly, it is an object of the present invention to provide food products having improved texture, flavor, shelf life, marketability, salability, processing efficiency and health benefits.

These and other features and advantages of this invention will become more apparent to those skilled in the art from the definitions, drawings, detailed description and examples provided herein.

### DEFINITIONS

“Particulate” means any food piece which is melt-resistant under cracker baking conditions.

“Unbaked” means not fully baked to a moisture content of less than 5%.

“Unbaked” includes the conditions of never having been heated or having been only partially heated.

“Weight percent” as used herein is based on the total weight of the composition unless indicated to the contrary.

Throughout the specification and claims, percentages and ratios are by weight and temperatures are in degrees Fahrenheit, unless otherwise indicated.

### BRIEF DESCRIPTION OF THE DRAWINGS

FIG. 1 is a schematic of an industrial scale embodiment of the present invention.

### DETAILED DESCRIPTION

The present invention provides processes to adhere food particulates to cracker dough, comprising: providing cracker dough; said dough having at least one surface; introducing dry saccharide and melt-resistant food particulates to at least one surface of the dough; baking the dough; saccharide and particulates so as to adhere the particulates to the baked dough. Preferred are those processes wherein the dry saccharide is introduced to the dough prior to introduction of said food particulate, particularly those wherein the saccharide is pressed into dough prior to introduction of said food particulate.

The products made from those processes are also provided, as are intermediates, or “ready-to-bake” products. Preferred are ready-to-bake cracker products, comprising: a flat cracker dough having dry saccharide and particulates on at least one surface.

Also provided are ready-to-eat food product, comprising: a flat, cracker-like base having dry saccharide and particulates baked onto at least one surface of the cracker.

Cracker dough is a starting ingredient in both the processes provided, and the method of making the present compositions. The cracker dough used in the present invention can be any type of edible cracker dough, including, for example, cracker dough with some sweeteners added, cracker doughs that are leavened, cracker doughs that have been fermented, cracker doughs with flavorings and/or cracker doughs with inclusions or toppings. Ideally, the cracker dough is of a consistency that it can be sheeted in an industrial sheeting machine.

The cracker dough useful in the present invention includes those selected from the group consisting of: multi-grain; whole grain; soda cracker; wheat cracker; butter cracker; cheese-flavored cracker; graham cracker; and flatbread cracker.

The cracker dough useful in the present invention is made according to methods generally known in the art, and preferably includes mixing flour, fat and moisture (ordinarily water) and most often, salt. Optional ingredients, such as flavors, inclusions, colors, nutritional supplements, emulsifiers, etc. may be added as well. The cracker dough is then sheeted, rolled, twisted or formed according to skill in the art.

The present invention includes combinations of doughs in one food item, for example one cracker formed by co-sheeting or co-extruding two doughs, each having a different color, flavor, types of inclusions, processing differences, etc. For that reason, the term “cracker” is not limited to traditional shapes; the final product can be any shape.

The flour component in cracker dough useful in the present invention may be any edible flour, including hard wheat flour, soft wheat flour, corn flour, rye flour, rice flour, barley flour, graham flour, whole wheat flour, high amylose flour, low amylose flour, and the like. Different grain constituents lend different texture, taste, and appearance to a baked good. Flours useful herein are of a conventional type and quality including cake flour, bread flour, and all-purpose flour. Whole wheat flours are preferred but other whole grain flours or processed flours conventionally used in the preparation of baked goods are also employed in full or partial substitution for the whole wheat flour. One protein range for wheat flour used in the present invention is between about 7 to 15% by weight of the flour. A general all-purpose flour is also usable. This type of all-purpose flour generally comprises a mixture of both hard and soft wheat flours, i.e., both high protein level and low protein level flours. Such all-purpose flours are most useful if the average protein content is about 8% by weight. While chlorinated flours are used herein, unchlorinated flours are also usable because chlorination is an expensive, though unnecessary flour processing step.

The fat component in a cracker dough of the present invention comprises any edible fat, oil, or shortening, including those that are solid at room temperature and those that are liquid at room temperature. Liquid shortenings or oils are usable and provide an advantage of ease of incorporation. Solid shortening is usable and provides an advantage of desirable mouthfeel upon consumption of the baked good. More commonly used are mixtures of liquid and solid shortenings. These mixtures are fluid or plastic depending, in part, on the level of solid fatty materials. Liquid shortening includes animal shortening, marine fats, vegetable or synthetic oil, such as sucrose polyesters, which are liquid at ordinary room temperature. The fat component of the present invention may comprise natural or hydrogenated oils, including soybean oil, cottonseed oil, canola (rapeseed) oil, peanut oil, safflower oil, sesame oil, sunflower oil, poppyseed oil, coconut oil, palm oil, palm kernel oil, olive oil, butterfat, cocoa butter, tallow, lard, babassue, corn oil, or combinations thereof.

Sweeteners may optionally be added to the cracker dough, but preferably at levels that do not interfere with the ability of the cracker dough to form a sheet. According to the invention, any suitable sugar can be present as a dough ingredient, including liquid or dry sugars. Typical sweeteners include corn syrup, high fructose corn syrup, maltose, malt syrup, malt syrup solids, honey, maple syrup, rice syrup, rice syrup solids, sorghum syrup, refiners syrup, corn syrup solids, dextrose, fructose, crystalline fructose, galactose, glucose, lactose, sucrose, brown or invert sugars, molasses and other compositions that substantially comprise sugars, whether crystalline, syrup or other physical form, and combinations thereof. Sugar substitutes can also be used as the sweetener according to the invention, including, for example, saccharine, acesulfone K, aspartame, sucralose, d-tagatose and the like. Such sugar substitutes can be used in addition to, or as a substitute for, the sweetener.

The dough optionally further comprise emulsifiers. Generally useful emulsifier components are lecithin's partially esterified polyhydric compounds having surface active properties. This class of emulsifiers includes among others, mono and diglycerides of fatty acids, such as monopalmitin, monostearin, monoolein, and dipalmitin; partial fatty esters of glycols, such as propylene glycol monostearate and monobehenate; higher fatty acid esters of sugars, such as the partial palmitic and oleic acid esters of sucrose; and phosphoric and sulphuric acid esters, such as dodecylglyceryl ether sulfate and monostearin phosphate. Other examples include the partial esters of hydroxy carboxylic acid such as lactic, citric, and tartaric acids with polyhydric compounds, for example, glycerol lacto palmitate and the polyoxyethylene ethers of fatty esters of polyhydric alcohols, such as polyoxyethylene ether of sorbitan monostearate or distearate. Fatty acids alone or esterified with a hydroxy carboxylic acid, e.g., stearyl-2-lactylate are also useful. In certain variations, all or a portion of the emulsifier component is pre-blended with the shortening or fat component. However, in other variations, a portion of the emulsifiers can be pre-hydrated and added along with the other wet ingredients. In still other variations, the emulsifiers can be plated onto various solid carriers such as flour, starch, sugars, milk powders, and the like, and admixed in with the various dry ingredients.

The dough of the present invention also optimally comprise salt, for flavor and function. Any food-grade salt is acceptable, although those in the art are aware that certain salts lend themselves to better results than others. For instance, the salt may be chosen from, but is not limited to, sodium chloride, potassium chloride, calcium chloride, naturally-occurring sea or other salts, or combinations thereof.

Food items of the present invention may also comprise a leavening component. The leavening component may be a chemical leavening system or yeast-based leavening system.

Optionally, the present dough-based food items may comprise additional flavorant components, inclusions, and/or nutritive enhancers.

Flavorants may be any of those known in the art and may include, vanilla, malt extract, honey, cheese, cheese powder, yeasts, spices, paprika, garlic, herbs flavors, fruit flavors, chocolate, etc. Inclusions may be any of those known in the art and may include oats, nutmeats, seeds, candy pieces, fruit pieces, etc. Nutritive enhancers may be any of those known in the art and may include vitamins, minerals, and fiber. Calcium carbonate may optionally be included as a dough conditioner or a source of calcium.

Useful dietary fiber includes both soluble and insoluble fiber, as well as sources generally known to contribute insoluble fiber, such as soy fiber, apple fiber, corn bran, wheat bran, wheat fiber, cocoa fiber, bamboo fiber, oat bran, barley bran, rye bran, triticale bran, cellulose, pea fiber, sugar beet fiber, and peanut fiber. Sources generally known to contribute soluble fiber include but are not limited to fructo-oligo saccharides, inulin, gum Arabic, gum ghatti, guar gumpectins, psyllium, carrageenans, xanthan, tragacanth, karaya, locust bean gum, agar, and alginates. Other fibers include polysaccharides, such as polydextrose and other complex sugar polymers or prebiotic fibers. When fiber is used it may substitute for flour and, preferably replaces 0-100% of the flour preferably 50-75%, most preferably 40-60%.

The present dough-based food items may also optionally comprise optionally enzymes, according to criteria and processes known to those in the art. For instance, proteases, lipases, carbohydrates may optionally be added, to modify the structure, function or flavor of the end product.

The parameters of the cracker dough useful in the present invention are indicated in Table I.

TABLE I
Cracker Dough Ingredient Ranges

| | Preferred | More Preferred | Most Preferred |
|---|---|---|---|
| INGREDIENT | % by total weight | % by total weight | % by total weight |
| Flour | 30-80 | 40-70 | 50-60 |
| Fat | 0-15 | 5-10 | 6-8 |
| Moisture | 5-25 | 10-20 | 13-18 |
| Salt | 0-1 | .4-.9 | .55-.75 |
| Sweetener | 0-15 | 5-10 | 6-8 |
| Flavorant | 0-15 | 0-10 | 2-5 |
| Leavening | 0-3 | 0-2 | .5-1.5 |

The inventive process results in a superior food product. Cracker dough can be prepared according to any known method, including industrial or small batch processes. The cracker dough is then ideally sheeted on an industrial sheeting device, according to those processes known in the art. Alternatively, the dough can be hand-formed, extruded, formed via other specialized mechanical means, or some combination thereof. For instance, dough can be sheeted and then die cut, or extruded as ropes and then hand-twisted, or any variation thereof.

In the present invention, the cracker dough is subjected to application of dry saccharide. The term “dry saccharide” includes any dry natural sugar or sugar-based compound, including, but not limited to dry forms of: raw, semi-refined or refined sugars derived from sugar cane; sugar beet; corn or honey; including brown sugar (sometimes referred to as “granulated brown sugar”); corn sweetener; invert sugar; and food grade monosaccharide's; disaccharides; and polysaccharides; including: glucose (dextrose); fructose; galactose; sucrose; lactose; maltose; and polydextrose; provided that the saccharide is used in a very low moisture, or powdered, crystallized, or other relatively solid form. The most preferred dry saccharide for use in the present invention is brown sugar.

This application of dry saccharide can be according to any known method, and ideally results in a thin layer of dry saccharide that has a relatively consistent thickness over the surface on which it is applied. The application need not be exact, however, and may optionally exclude surface area according to design considerations. For instance, a template, stencil, mask or other method may be used to limit the dry saccharide to application in a pattern such as a swirl, circle, or stripes, so that particulates are preferentially adhered in those designs.

Particulates may be added concurrently with the dry saccharide, in a single step, or before or after the application of the dry saccharide. Particulates include, but are not limited to: grains; nut meats; seeds; hard candy pieces; dried fruit pieces; fruit rind; rice bubbles; and any ready-to-eat cereal piece. When grain is desired, any whole, flaked or puffed grain can be used, such as oats, wheat, barley, rye, and triticale. Any suitable method can be used to process the grain into edible particulates. Oat flakes, wheat flakes, barley flakes, rye flakes, and triticale flakes can be obtained from their respective whole grain in any manner known to those skilled in the art and in any desired size range. Processes for puffing grains are also known to those skilled in the art, and the size of the puffed grain particulate can be manipulated according to known methods. The grain may be raw, partially-cooked (heat treated), fully cooked, or any range in between.

The size of the particulates is preferably in the range from 1-10 preferably 2-8 mm, or most preferably from 3-6.5 mm. The particulates may be pre-cooked, or may be baked during the inventive process.

If the particulates are added concurrently with the dry saccharide, the dry saccharide and the particulates may be mixed or tumbled together prior to application on the dough, so as to prevent any sticking or clumping. Depending on the qualities of the particulates, however, pre-mixing may not be necessary, and may, in fact, be less desirable.

The present dough-based food products include those embodiments wherein the particulates comprise approximately 1 to 90 percent of the finished, baked product, by weight. Preferably particulates comprise approximately 5 to 50 percent of the finished, baked product, by weight. Most preferably, particulates comprise approximately 10 to 25 percent of the finished, baked product, by weight.

The present dough-based food products include those embodiments wherein the dry saccharides comprise approximately 1 to 50 percent of the finished, baked product, by weight. Preferably, dry saccharides comprise approximately 1 to 25 percent of the finished, baked product, by weight. Most preferably, dry saccharides comprise approximately 1 to 10 percent of the finished, baked product, by weight.

When the particulates are added before or after the dry saccharide, the particulates may be deposited on the dough in any manner. Preferably, the particulates and dry saccharide are deposited so that the particulates and the dry saccharide are contiguous with the dough and each other, ensuring highest probability of forming a bond during baking, and reducing waste. Any particulates that are not in contact with dry saccharide and dough will not bond to the dough, but can optionally be recycled using air jet recovery systems as known in the art.

The treated dough is baked prior to packaging, and distributed as a finished product. Baking can be accomplished according to any known means, and preferably includes at least one stage at 350° F. or more. The temperature is generally in the range of 350-600° F., and should be as low as possible to result in the dry saccharide becoming liquid, but not so high as to burn the cracker dough. The baking step ideally reduces the moisture content of the dough to less than 8%, preferably less than 5%, most preferably from 1-5%.

While not wishing to be bound by any particular theory, it is possible that during the baking process, the dough releases steam and the dry saccharide becomes molten. The three-dimensional structure of the saccharide may change so that when the product cools, the saccharide traps the particulates within a new structure. This phase change may result in particulates that were originally not in contact with saccharide shifting so as to come into contact with the molten saccharide and thereafter bound to the cracker. However, a surprising aspect of this invention is that the shelf life of the baked product is the same as a baked cracker without a saccharide/topping layer, provided that the humidity is low. In other words, if indeed moisture escaping from the dough is trapped within the saccharide, the saccharide surprisingly does not later lose the moisture to the cracker, unacceptably rendering it stale.

In the present invention, a dough-based food item with various appearances are provided. In one embodiment, a flat food piece has particulates on one surface only. The food item need not be flat, however. The present invention includes those embodiments wherein the food item is curved, toroid, cubed or otherwise less than flat. Decorative features, such as stripes or designs, are within the scope of the present invention. Moreover, the decorative features can be accomplished by applying different particulates to different sections of the dough. In one such embodiment, there is provided a flat wafer, with chocolate pieces on one surface and almond pieces on the other surface. In another such embodiment, there is provided a flat wafer, with whole grain pieces on one side and dried fruit pieces on the other surface.

Moreover, the particular percentage of surface area devoted to adhesion of particulates need not be limited to fifty percent, although a preferred embodiment of the present invention is one wherein one flat surface has particulates adhered to it. The present invention includes ratios of particulate to non-particulate surfaces, including 10:90, 20:80, 30:70, 40:60, 50:50, 60:40, 70:30, 80:20 and 90:10.

### EXAMPLES

### Example 1

### Preparation of a Dill and Rye Cracker with Caraway Seeds

| CRACKER DOUGH INGREDIENTS | MEASUREMENT | |
|---|---|---|
| unbleached white flour | 2 | cups |
| whole wheat flour | .5 | cup |
| rye flour | .5 | cup |
| salt | 1 | teaspoon |
| unsalted butter, softened | .5 | cup |
| warm water | .5 | cup |
| finely snipped dill leaves | 3 | tablespoons |
| salt | 1 | teaspoon |
| dill seed | 1 | teaspoon |

The flours and one teaspoon salt are mixed in a large bowl. The softened butter is processed in a food processor with the flour and salt mixture to make a fine meal. The warm water and dill leaves are mixed into the flour, salt and butter mixture. The dough is kneaded for five minutes, then rolled on a lightly floured surface into a ⅛ inch rectangle. The top of the cracker is sprinkled somewhat evenly with ⅓ cup crystalline maltose and sprinkled somewhat evenly with ¼ cup caraway seeds. The cracker is baked in a 450° F. oven for 10-12 minutes or until the crystals liquefy. The cracker is cooled flat until the crystals solidify.

### Example 2

### Preparation of a Graham Cracker with Frosted Wheat Flakes on the Surface

| CRACKER DOUGH INGREDIENTS | MEASUREMENT | |
|---|---|---|
| oil | ¼ | cup |
| honey | ⅓ | cup |
| molasses | 2 | tablespoons |
| vanilla | 1 | teaspoon |
| whole wheat flour | 2½ | cup |
| baking powder | 1 | teaspoon |
| salt | ¼ | teaspoon |
| cinnamon | 1 | teaspoon |
| milk | ¼ to ½ | cup |

Oil, honey, molasses, milk and vanilla are mixed in a first bowl to form a liquid mix. Flour, baking powder, salt and cinnamon are combined in a second bowl to form a dry mix. The dry mix is added to the liquid mix. The combination is mixed well to form a dough. The dough is divided in half and such half is rolled directly onto a baking sheet. A top surface of the dough is sprinkled somewhat evenly with ¼ cup brown sugar and then sprinkled somewhat evenly with ½ cup crushed wheat flakes. The topped cracker dough is then baked at 500° F. for approximately 10 minutes and subsequently cooled.

### Example 3

### Preparation of a Butter Cracker with Crushed Corn Flakes® on the Surface

| CRACKER DOUGH INGREDIENTS | MEASUREMENT | |
|---|---|---|
| flour | 3 | cups |
| unsalted butter | ¾ | cup |
| sugar | 3 | tablespoons |
| salt | 1½ | teaspoons |
| milk | 1 | cup |

The first four ingredients are crumbled together. Enough milk is then added and stirred to make a stiff dough. The dough is rolled as thin as possible. The dough is then sprinkled somewhat evenly with ⅔ cups crushed Corn Flakes® that have been tossed with ⅓ powdered lactose. The dough is then cut into oval shapes and pricked with a fork. The cracker is baked at 475° F. for approximately 10 minutes and subsequently cooled.

### Example 5

### Preparation of a Flavored Cracker with Bacon Pieces and Peppercorn on the Surface

| CRACKER DOUGH INGREDIENTS | MEASUREMENT | |
|---|---|---|
| bacon, cooked and crumbled | ¼ | pound |
| all-purpose flour | 1½ | cup |
| cheddar cheese, shredded | ½ | cup |
| parmesan cheese, grated | 2 | tablespoons |
| baking soda | ½ | teaspoon |
| salt | ¼ | teaspoon |
| black pepper, ground | ⅛ | teaspoon |
| sour cream | ½ | cup |
| bacon drippings | 3 | tablespoons |

Bacon, flour, cheeses, baking soda, salt and pepper are combined in a bowl. Sour cream is stirred into the combination. Bacon drippings are stirred into the combination and the combination is well mixed to form a dough. The dough is rolled into a ⅛ inch thick sheet, sprinkled somewhat evenly with ¼ cup poydextrose, ¼ cup bacon pieces and 1 tablespoon cracked pepper, and cut into 1½ inch diamonds. The crackers are baked at 525° F. for approximately 9 minutes and subsequently cooled.

### Example 6

### Industrial-Scale Method for Making a Cracker with Adhered Particulates

Sweetened cracker dough was made by mixing the following ingredients in a horizontal mixer, according to the following quantities.

| Dough Ingredients | Weight % | Amount (lb) |
|---|---|---|
| Palm Shortening | 7.500 | 22.50 |
| Granulated Sugar | 8.500 | 25.50 |
| Salt | 0.650 | 1.95 |
| Calcium Carbonate | 2.000 | 6.00 |
| Vitamin Blend | 0.150 | 0.450 |
| Honey | 2.000 | 6.00 |
| Malt Extract | 1.000 | 3.00 |
| Vanilla Flavor | 1.500 | 4.50 |
| Soft Wheat Flour (8% Protein) | 55.000 | 165.00 |
| Modified Waxy Maize Starch | 3.000 | 9.00 |
| Cereal Fines | 3.000 | 9.00 |
| Ammonium Bicarbonate | 0.150 | 0.45 |
| Sodium Bicarbonate | 0.500 | 1.50 |
| Sodium Acid Pyrophosphate (SAPP 28) | 0.700 | 2.10 |
| Water | 14.350 | 43.05 |

The dough was brought to a temperature if 80-90° F. fed into a dough sheeter and a dough sheet was thereby created. The dough sheet was then passed, via a processing conveyor, through a first set of reduction rolls, and subsequently, a second set of reduction rolls. Granulated brown sugar was placed in a hopper above the processing conveyor and the brown sugar was then sprinkled on top of the reduced dough sheet. The dough sheet with granulated brown sugar atop was then passed through a subsequent set of reduction rolls via the conveyor. Crushed cereal flakes from a hopper above the processing conveyor were then applied to the top of the dough sheet, and in contact with the pressed granulated brown sugar.

The percentage of ingredients at this stage was:

| | |
|---|---|
| Dough | 82.50 |
| Granulated brown sugar | 7.50 |
| Crushed Corn Flakes ® | 5.00 |
| Crushed Special K ® Flakes | 5.00 |

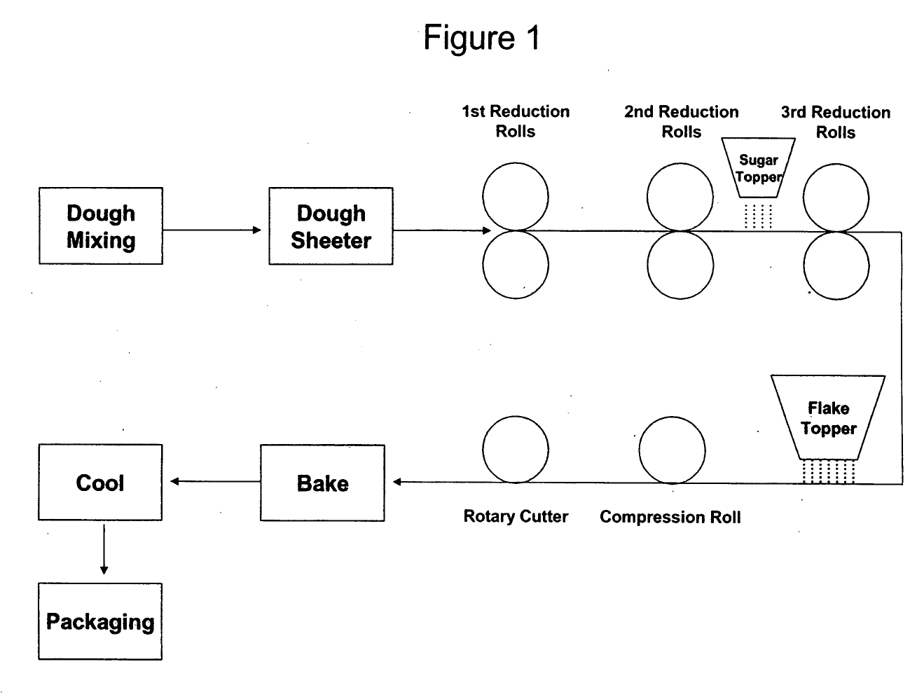

The dough with granulated brown sugar and crushed cereal flakes atop was then passed through a compression roll. The dough sheet was subsequently cut into rectangles via a rotary cutter, baked in a continuous oven at zones ranging from 360-490 degrees. The baked dough was cooled on a conveyor, and packed. This process is described in FIG. 1.

The foregoing invention has been described in accordance with the relevant legal standards, thus the description is exemplary rather than limiting in nature. Variations and modifications to disclosed embodiments may become apparent to those skilled in the art and are within the scope of the invention.

What is claimed is:

1. A process to adhere food particulates to cracker dough, comprising:
providing cracker dough, said dough having at least one surface;
introducing dry saccharide and melt-resistant food particulates to at least one surface of said dough;
baking said dough, saccharide and particulates so as to adhere the particulates to the baked dough.

2. A process of claim 1, wherein said dry saccharide is introduced to said dough prior to introduction of said food particulate.

3. A process of claim 2, wherein said dry saccharide is pressed into said dough prior to introduction of said food particulate.

4. A process of claim 1, wherein the dry saccharide is selected from the group consisting of: dry cane sugar, dry sugar beet sugar, dry corn sugar, dry honey, dry brown sugar, dry corn sweetener, dry invert sugar; dry monosaccharides, dry disaccharides, dry polysaccharides, dry glucose (dextrose), dry fructose, dry galactose, dry sucrose, dry lactose, dry maltose, and dry polydextrose.

5. A process of claim 1, wherein said particulate is selected from the group consisting of: grains, nut meats, seeds, hard candy pieces, dried fruit pieces, fruit rind, rice bubbles, ready-to-eat cereal pieces; whole grain, flaked grain, puffed grain, oats, wheat, barley, rye, triticale, oat flakes, wheat flakes, barley flakes, rye flakes, triticale flakes; cooked grain, heat treated grain, partially-cooked grain, and fully cooked grain.

6. A process of claim 1, wherein said dough comprises a nutritive enhancer selected from the group consisting of: vitamins, minerals, and fiber.

7. A process of claim 1, wherein said dough comprises less than 15% fat.

8. A process of claim 8, wherein said dough comprises less than 15% sweetener.

9. A process of claim 9, wherein said saccharide is brown sugar.

10. A process of claim 10, wherein said particulate is ready-to-eat cereal piece.

11. A process of claim 11, wherein said cracker dough is industrially sheeted.

12. A ready-to-bake cracker product, comprising: a flat cracker dough having dry saccharide and particulates on at least one surface.

13. A ready-to-eat food product, comprising: a flat, cracker-like base having dry saccharide and particulates baked onto at least one surface of the cracker.

14. A product of claim 14, wherein the dry saccharide is selected from the group consisting of: dry cane sugar, dry sugar beet sugar, dry corn sugar, dry honey, dry brown sugar, dry corn sweetener, dry invert sugar; dry monosaccharides, dry disaccharides, dry polysaccharides, dry glucose (dextrose), dry fructose, dry galactose, dry sucrose, dry lactose, dry maltose, and dry polydextrose.

15. A product of claim 14, wherein said particulate is selected from the group consisting of: grains, nut meats, seeds, hard candy pieces, dried fruit pieces, fruit rind, rice bubbles, ready-to-eat cereal pieces; whole grain, flaked grain, puffed grain, oats, wheat, barley, rye, triticale, oat flakes, wheat flakes, barley flakes, rye flakes, triticale flakes; cooked grain, heat treated grain, partially-cooked grain, and fully cooked grain.

16. A product of claim 14, wherein said dough comprises a nutritive enhancer selected from the group consisting of: vitamins, minerals, and fiber.

17. A product of claim 14, wherein said saccharide is brown sugar.

18. A product of claim 17, wherein said particulate is ready-to-eat cereal piece.
